(19) United States
(12) Patent Application Publication
(10) Pub. No.: US 2016/0327053 A1
(43) Pub. Date: Nov. 10, 2016

(54) INTEGRATED PRESSURIZED PUMP SHAFT SEAL ASSEMBLY AND METHOD OF USE THEREOF

(71) Applicants: Peter Francis VAN-DE-VELDE, Burnaby (CA); TOYO PUMPS NORTH AMERICA CORP., Burnaby (CA)

(72) Inventors: Peter Francis Van-De-Velde, Burnaby (CA); Nicholas James Guenther, Burnaby (CA)

(21) Appl. No.: 15/108,755

(22) PCT Filed: Jan. 5, 2015
(86) PCT No.: PCT/CA2015/000022

§ 371 Date: Jun. 28, 2016

Related U.S. Application Data
(60) Provisional application No. 61/923,675, filed on Jan. 5, 2014.

(51) Int. Cl. F04D 29/10; F04D 29/44; F04D 29/58; F04D 29/06; F04D 13/08; F04D 1/00

(52) U.S. Cl. CPC F04D 29/106; F04D 13/08; F04D 1/00; F04D 29/5806; F04D 29/06; F04D 29/445; F05B 2210/11; F05B 2240/30; F05B 2240/57; F05B 2260/205

(57) ABSTRACT

An integrated pressurized pump shaft seal assembly for a rotary fluid pump is disclosed. The seal assembly may include an oil reservoir; an integrated centrifugal oil pump directly attached to and rotatable by a pump shaft and fluidly connected to receive oil from the oil reservoir; a seal chamber fluidly connected to receive pressurized oil from the centrifugal oil pump and comprising: a pump shaft bearing adapted to be lubricated by said oil, and a mechanical shaft seal surrounding the pump shaft and adapted to seal the seal chamber against ingress of a pumped fluid. The integrated pressurized pump shaft seal assembly may also use first and second mechanical shaft seals. A rotary fluid pump including a pump motor, pump shaft, pump impeller assembly and integrated pressurized pump shaft seal assembly is disclosed. A method of preventing seal failure in a rotary fluid pump is also disclosed.

### 1. TECHNICAL FIELD

The present invention relates generally to pump shaft seals and methods of use thereof. More specifically, the present invention relates to pump shaft seal assemblies such as for submersible or semi-submersible pumps which are adapted to be pressurized by an integrated seal pressure pump, and methods of use thereof.

### 2. BACKGROUND OF THE INVENTION

Rotary fluid pumps are typically prone to malfunction and/or failure due to seal failure, such as failure of seals around the pump shaft that typically seal against ingress of pumped fluid into pump shaft bearings and/or a pump motor such as a typical electrical pump motor. Particularly in rotary pumps that pump abrasive fluids and slurries, wear of pump shaft seals and eventual failure of the shaft seals may be accelerated or worsened, leading to premature or undesirably frequent requirement for repair, servicing and/or replacement of pumps. Such undesirable pump malfunction and/or failure may result in expensive downtime and maintenance, leading to lost time and expense.

In some submerged pumps known in the art for operation at significant depths, pressure compensated seals may be used typically requiring external sources of air or other fluid pressure to balance pressures on both sides of pump seals. Such typical external pressure sources known in pressure compensated submerged pumps may undesirably add complexity and expense and require reliance on pressure compensation equipment external to the pump system which may be undesirable in many applications where lower cost, reliability and simplicity are desirable.

Accordingly, there remains a desire for improved rotary pump seals and methods for their application that address some of the limitations of the pump seals known in the art.

### 3. SUMMARY OF THE INVENTION

It is an object of the present invention to provide an integrated pressurized pump seal assembly that addresses some of the limitations of the prior art.

It is a further object of the present invention to provide a method of using an integrated pressurized pump seal assembly that addresses some of the limitations of the prior art.

In one embodiment, an integrated pressurized pump seal assembly pump design may be provided that desirably substantially prevents a pumped fluid, such as an abrasive fluid or slurry from seeping up the rotating pump shaft to the pump shaft bearings by leakage through a lower seal, such as a typical mechanical shaft seal. Mechanical seals may typically leak a small amount of oil or other seal lubricating fluid by the nature of the mechanical seal design and may typically be prone to system upsets. In one embodiment according to the present invention, a self-pressurized pump seal chamber is provided in an integrated pressurized pump seal assembly, wherein the oil within the pump seal chamber may desirably be maintained at a pressure greater than the sump pressure of the surrounding pumped fluid. Therefore desirably grit, moisture and/or other contamination cannot enter and damage the seal assembly under standard operating conditions, and desirably also following routine upsets such as stopping and starting of the pump such as to desirably provide pump seal and bearing protection under most conditions except catastrophic failure of the seal assembly. Accordingly, implementation of the integrated pressurized pump seal assembly according to one embodiment of the present invention may desirably reduce maintenance and outage costs to a pump user.

In a further embodiment of the present invention, an integrated pressurized pump shaft seal assembly for a rotary fluid pump is provided, where the integrated pressurized pump shaft seal assembly comprises: an oil reservoir; an integrated centrifugal oil pump directly attached to and rotatable by a pump shaft and fluidly connected to receive oil from the oil reservoir; a seal chamber fluidly connected to receive pressurized oil from the centrifugal oil pump and comprising: a pump shaft bearing adapted to be lubricated by said oil, and a mechanical shaft seal surrounding the pump shaft and adapted to seal the seal chamber against ingress of a pumped fluid. In another embodiment, the integrated pressurized pump shaft seal assembly may comprise first and second mechanical shaft seals.

In another embodiment according to the present invention, a rotary fluid pump comprising a pump motor, a pump shaft connected to said pump motor and a pump impeller, and further comprising an integrated pressurized pump shaft seal assembly adapted for connection to the pump shaft, where the integrated pressurized pump shaft seal assembly comprises: an oil reservoir; an integrated centrifugal oil pump directly attached to and rotatable by a pump shaft and fluidly connected to receive oil from the oil reservoir; a seal chamber fluidly connected to receive pressurized oil from the centrifugal oil pump and comprising: a pump shaft bearing adapted to be lubricated by said oil, and a mechanical shaft seal surrounding the pump shaft and adapted to seal the seal chamber against ingress of a pumped fluid.

In yet another embodiment according to the present invention, a method of preventing seal failure in a rotary fluid pump is provided, where the method comprises:

providing a rotary fluid pump comprising an integrated pressurized pump shaft seal assembly comprising: an oil reservoir; an integrated centrifugal oil pump directly attached to and rotatable by a pump shaft and fluidly connected to receive oil from the oil reservoir; a seal chamber fluidly connected to receive pressurized oil from the centrifugal oil pump and comprising a pump shaft bearing adapted to be lubricated by said oil; and a mechanical shaft seal surrounding the pump shaft and adapted to seal the seal chamber against ingress of a pumped fluid; and

operating said rotary fluid pump by rotating said pump shaft with a pump motor wherein said pump shaft also directly rotates said integrated oil pump to pressurize oil in said seal chamber to prevent ingress of a pumped fluid into said seal chamber.

Further advantages of the invention will become apparent when considering the drawings in conjunction with the detailed description.

### 4. BRIEF DESCRIPTION OF THE DRAWINGS

The apparatus and methods of several embodiments of the present invention will now be described with reference to the accompanying drawing figures, in which:

FIG. 1 is a schematic view of an integrated pressurized pump shaft seal according to an embodiment of the present invention, and a pump apparatus comprising the same, according to another embodiment of the present invention.

FIG. 2 is a longitudinal cross sectional view of an integrated pressurized pump shaft seal according to an embodiment of the present invention, which is part of a pump apparatus comprising the same, according to a further embodiment of the invention.

FIG. 3 is an inset longitudinal cross sectional view of internal details of an integrated pressurized pump shaft seal according to an embodiment of the present invention, and part of a pump apparatus comprising the same, according to a further embodiment of the invention.

### 5. DETAILED DESCRIPTION OF THE INVENTION

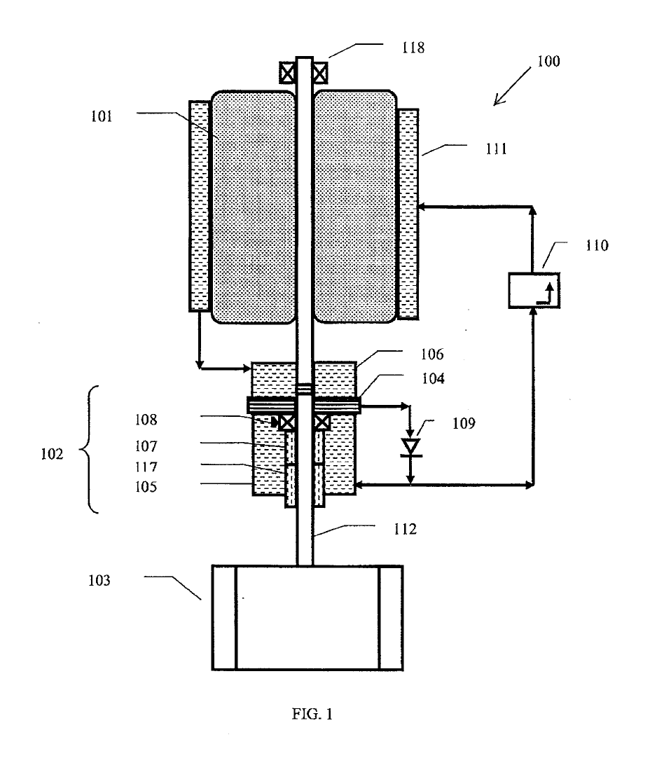

Referring to FIG. 1, a schematic view of an integrated pressurized pump shaft seal assembly 102 is shown, according to an embodiment of the present invention, and a pump apparatus 100 is also shown comprising the same, according to another embodiment of the present invention. In one embodiment, the pump 100 may comprise a rotary slurry or other fluid pump such as for pumping one or more of fluids, fluid/solid suspensions and slurries, for example. In a particular embodiment, the pump 100 may comprise a submersible and/or semi-submersible pump such as a semi-submersible slurry pump for example, and may comprise a pump motor such as an electric pump motor 101, an integrated pressurized pump shaft seal such as integrated pressurized pump shaft seal assembly 102, and a pump impeller/chamber assembly or “wet end” 103, for example. In one such embodiment, the electric pump motor 101 may drive the pump impeller assembly 103 through pump shaft 112, which may extend through the integrated pressurized pump shaft seal assembly 102, and may be supported by upper shaft bearings 118 and lower shaft bearings 108, for example.

In one embodiment, the integrated pressurized pump shaft seal assembly 102 may comprise at least one mechanical shaft seal, such as a mechanical shaft seal comprising upper seal face 107 and lower seal face 117 which are located within a seal chamber 105 that surrounds the upper seal face 107 and lower pump shaft bearings 108, and which is filled with oil or other suitable seal and/or bearing lubricating fluid. In a preferred embodiment, the integrated pressurized pump shaft seal assembly 102 comprises a dual mechanical seal arrangement comprising an upper mechanical seal 107, and a lower mechanical seal 117, which each comprise two mechanical seal faces engaged in rotational sealing contact with each other to provide a mechanical shaft seal on pump shaft 112. Mechanical seals 107, 117 may comprise any suitable mechanical seal design and/or materials, such as comprising silicon and/or tungsten carbide seal surfaces, for example, and in one embodiment of the present invention, upper and lower mechanical seals 107, 117 may each be provided as a cartridge mechanical seal, for example. Integrated pressurized pump shaft seal assembly 102 including mechanical seals 107 and 117 and further comprising a seal chamber 105 containing oil (or any other suitable seal and/or bearing lubricating fluid for example) may desirably be pressurized at a positive pressure above the ambient or sump pressure outside the seal chamber 105 and may therefore desirably prevent a pumped slurry, fluid or other contaminants from a submerged pump wet end 103 from entering seal chamber 105 containing and protecting the lower shaft bearings 108, and protecting the pump motor 101, for example. In one embodiment, the upper and lower mechanical seals 107 and 117 may also desirably protect pump motor 101, and any other pump components in the “dry end” of the pump from exposure to a pumped slurry, fluid or other contaminants from a submerged pump wet end 103, for example.

In one embodiment, the integrated pressurized pump shaft seal assembly 102 further comprises an oil pump 104 which may be desirably directly attached to and integrated with the pump shaft 112, such that the oil pump 104 is rotated and thereby powered directly by the pump shaft 112. In one embodiment, the oil pump 104 comprises a centrifugal impeller pump 104, such as a radial hole impeller pump, which is integrated with and rotated by the pump shaft 112 and is operable to provide a positive oil pressure within the seal chamber 105, to desirably pressurize seal chamber 105 to a desirably higher pressure than the surrounding sump or pumped fluid (such as a slurry) pressure inside the wet end 103 of the pump, or outside the seal chamber 105, for example, such as to desirably exclude a pumped fluid such as a slurry from entering the seal chamber 105, the upper and lower mechanical seals 107 and 117, and to desirably prevent contamination of and/or damage to bearings 108, or pump motor 101, for example. In one particular embodiment, pressurized seal chamber 105 may desirably be pressurized by oil pump 104 to a positive pressure of about 10 to 50 psi above the ambient pressure of a pumped fluid outside the seal chamber 105, such as the ambient pressure of pumped fluid or slurry in wet end 103, for example. In one embodiment, integrated pressurized pump shaft seal assembly 102 further comprises an oil reservoir 106, typically situated above seal chamber 105, and operable to contain and supply oil (or another suitable seal and/or bearing lubricating fluid) to oil pump 104, to be pressurized and supplied to seal chamber 105 at a positive pressure above the sump or external pressure of a pumped fluid or slurry outside of the seal chamber 105. In a particular embodiment, oil pump 104, such as a radial hole centrifugal impeller pump, may be attached to and integrated with pump shaft 112 such as by retaining oil pump 104 to shaft 112 by means of a retaining locknut. In a further such embodiment, integrated oil pump 104, bearings 108, and optionally a shaft sleeve (not shown) may be attached to pump shaft 112 by a common retaining locknut, for example, such that rotation of the pump shaft 112 by pump motor 101 is operable to rotate integrated oil pump 104. In a particular embodiment, bearings 108 may be open to seal chamber 105, such that oil or another suitable lubricating fluid pressurized in chamber 105 by oil pump 104 may provide lubrication to bearings 108. In a further such embodiment, bearings 108 may comprise a bearing housing (not shown) which may desirably comprise a bearing oil pool or reservoir which may retain residual oil to lubricate bearings 108 even if seal chamber 105 loses pressure and is at least partly drained of oil, such as in the event of failure of mechanical seals 107, 117, for example. In a particular embodiment, upper and lower mechanical seals 107, 117, may desirably be configured to sealingly accommodate a desired pressure differential between pressurized seal chamber 105 and the lower ambient pressure of a pumped fluid outside the seal chamber 105.

In one embodiment, integrated pressurized seal assembly 102 further comprises a check valve 109, located between integrated oil pump 104 and pressurized seal housing 105. In a particular such embodiment, check valve 109 may desirably be operable to prevent backflow of oil from seal chamber 105 to oil reservoir 106, through integrated oil pump 104, such as may otherwise occur upon shutdown of the pump motor 101, and may undesirably lead to contamination of oil reservoir 106 following eventual failure of mechanical seals 107, 117, for example. Since mechanical seals 107, 117 are subject to wear and eventual failure upon extended operation of pump 100, even with the assistance of pressurized seal chamber 105 which may desirably exclude pumped fluid (such as a pumped slurry) from entering mechanical seals 107, 117 during normal operation, check valve 109 may also be operable to close upon detection of failure of lower mechanical seal 117, such as to keep pumped fluid and/or moisture from entering oil reservoir 106, such as through the integrated oil pump 104. In one such embodiment, check valve 109 may comprise a pressure-actuated valve such that the check valve 109 closes if the pressure in the seal chamber 105 decreases below a desired minimum pressure, and whereby such closing of valve 109 may desirably reduce or prevent admission of fluid to oil reservoir 106. In another such embodiment, a sensor (not shown) may be provided that is operable to detect failure of lower mechanical seal 117, and to trigger closure of check valve 109 upon such failure. In another embodiment, a sensor may also be provided that may trigger an alarm or other suitable indication (such as an indicator light or signal for example) to notify a user of the failure of the lower mechanical seal 117. In a further optional embodiment, one or more sensors may also be provided to detect one or more of: failure of lower or upper mechanical seals 107, 117; low oil level in oil reservoir 106; water and/or moisture ingress in to seal chamber 105; and a drop in oil pressure in seal chamber 105 below a desired minimum level; faults, and such sensor(s) may further be operable to trigger an alarm or other suitable indication to notify a user of one or more of such faults.

In another embodiment of the present invention, the pump apparatus 100 may additionally comprise a cooling jacket 111, such as for circulating oil (or other suitable lubricating fluid) from oil reservoir 106 under pressure from oil pump 104, to cool pump motor 101 (such as a typical electric pump motor 101). In one such embodiment, such as for use in a semi-submerged pump, oil from oil reservoir 106 may be pumped into seal chamber 105 by integrated oil pump 104 driven by rotation of pump shaft 112, to pressurize seal chamber 105 at a positive pressure above an outside ambient fluid pressure, and a portion of oil in seal chamber 105 may be admitted through a pressure reducing valve 110 (which may normally be open) to circulate cooling jacket 111 surrounding at least a portion of pump motor 101. Such circulation of oil from seal chamber 105 through pressure reducing valve 110 to cooling jacket 111 and back to oil reservoir 106 before returning to seal chamber 105 through oil pump 104, may desirably circulate heat from pump motor 111 to seal chamber 105, where the circulated oil may be cooled by typically cooler surrounding ambient pumped fluid located outside of the seal chamber 105. In one such embodiment, pressure reducing valve 110 may desirably be configured to maintain a desired minimum positive pressure in seal chamber 105 such as by limiting and/or controlling flow of oil through valve 110 and cooling jacket 111, for example, to maintain pressurization of seal chamber 105 at or above the desired minimum positive pressure. In a particular embodiment, seal chamber 105 and any optional surrounding housing around seal chamber 105 (not shown) may desirably be comprised of a suitably thermally conductive material, such as aluminum for example, so as to desirably allow dissipation of heat from oil in seal chamber 105 (and optionally also from oil reservoir 106) to typically cooler pumped fluid located outside of the chamber 105 and/or housing. In one such embodiment, walls of seal chamber 105 and/or a further optional seal chamber housing may additionally include cooling fins or other suitable structures such as to improve heat dissipation from the oil chamber 105 to an ambient fluid outside of the chamber.

Similar to the check valve 109 described above, pressure reducing valve 110 may also be operable to close upon detection of failure of lower mechanical seal 117, such as to keep pumped fluid and/or moisture from entering cooling jacket 111. In one such embodiment, a sensor (not shown) may be provided that is operable to detect failure of lower mechanical seal 117, and to trigger closure of pressure reducing valve 110 upon such failure. In another embodiment, a sensor may also be provided that may trigger an alarm or other suitable indication (such as an indicator light or signal for example) to notify a user of the failure of the lower mechanical seal 117. In a further embodiment, following failure of the lower mechanical seal 117, the upper mechanical seal 107 may desirably operate to prevent ingress of moisture, pumped fluid or other contaminants from entering the pump motor 101 and desirably also the seal chamber 105 and bearing 108 until the pump may be repaired and/or replaced. In another embodiment, an optional oil filter (not shown) may be provided such as between the seal chamber 105 and the check valve 109, or between the oil reservoir 106 and the oil pump 104, for example, to desirably provide additional protection against contamination of the oil in seal chamber 105 and provide increased bearing life of bearings 108. In yet another embodiment, in a case following failure of both upper and lower mechanical seals 107, 117, the oil pump 104 may desirably act as a dynamic seal such as by pumping any fluid (such as including contaminating pumped fluid or other contaminants) entering the oil reservoir 106 back down to seal chamber 105, and away from pump motor 101, thereby desirably preventing any such fluid from entering and potentially damaging pump motor 101 and desirably providing an additional protection against pump motor failure. In yet a further embodiment, in a case following interruption, upset or power failure of pump 100, integrated pressurized seal assembly 102 may desirably provide for gradual reduction of positive pressure within seal chamber 105 such as by providing for closure of backflow valve 109 as pressure in seal chamber declines below a desired minimum pressure, and thereafter by allowing gradual bleed down of pressurized oil in seal chamber 105 through mechanical seals 117, 107, so as to desirably maintain exclusion of a pumped fluid from the seal chamber 105 and oil reservoir 106, for example, thereby protecting bearings 108 and pump motor 101, respectively.

In one embodiment of the present invention, integrated pressurized seal assembly 102 may further comprise a pressurized oil diffuser (not shown) such as located between oil pump 104 impeller and pressurized seal chamber 105, so as to desirably convert fluid velocity of oil pumped by oil pump impeller 104 to static pressure for pressurizing seal chamber 105 to a desired positive pressure relative to outside ambient fluid pressure. In a particular such embodiment, integrated pressurized seal assembly 102 additionally comprises a bearing housing (not shown) within seal chamber 105 and containing shaft bearing 108, wherein the bearing housing includes a diffuser for receiving pressurized pumped oil from oil pump impeller 104 and converting fluid velocity of the pumped oil into static pressure within seal chamber 105, for example. In a further such embodiment, the diffuser may additionally include at least one of splitting and guiding channels (not shown) oriented to divert and/or direct additional pumped oil flow into pressure reducing valve 110 and thereby increasing oil flow to cooling jacket 111, for example. In another optional embodiment, oil pump 104 may additionally comprise one or more vent channels operable to vent a portion of oil pressurized by pump 104 to a sump external to seal chamber 105, such as to desirably reduce overpressure on seal chamber 105, for example.

In another embodiment of the present invention, seal chamber 105 may comprise one or more baffles or other suitable flow directing structures (not shown) effective to desirably reduce swirling and/or creation of air pockets or cavitation of pumped oil in the vicinity of seal faces of one or more of upper and lower mechanical seals 107, 117, for example. In an optional embodiment, oil pump 104, such as centrifugal radial impeller oil pump 104 may desirably be oriented in a direction such that an axial thrust load on pump shaft 112 due to oil pump 104 integrated with pump shaft 112 may desirably act in a direction opposite to one or more other axial thrust loads on pump shaft 112, such as opposite to an axial thrust load due to wet end 103 of pump 100, such as to desirably reduce imbalance in axial thrust loads on shaft 112 which may be borne by bearings 108, 118, for example. In another embodiment directed to pumps used for submersion at significant depths in a pumped fluid, integrated pressurized pump seal assembly 102 may desirably comprise a pressure compensation device (not shown) which is operable to desirably control or increase an operational oil pressure in pressurized seal chamber 105, such as to maintain a positive pressure of seal chamber 105 over an ambient pumped fluid pressure outside seal chamber 105. In another optional embodiment, oil reservoir 106 may additionally comprise an air relief valve (not shown), such as to relieve any aid in reservoir 106, such as may otherwise undesirably result in airlock of the oil reservoir/pump/seal chamber oil pressurization system of the assembly 102. In an alternative such embodiment, an air relief valve may also assist in adding oil to oil reservoir 106 such as to allow release of air from oil reservoir 106 when filling and/or refilling the assembly 102 with oil, for example. In yet another alternative embodiment, an air relief valve may admit air to reservoir 106 if desired, for example.

In one embodiment of the present invention, a rotary fluid (and/or slurry) pump 100 comprising an integrated pressurized pump shaft seal assembly 102 is provided, wherein the integrated pressurized seal assembly 102 is configured or otherwise adapted for use with a desired pump motor 101 and impeller assembly/wet end 103 to desirably provide a pressurized seal assembly to protect bearings 108 and pump motor 101, for example. In yet another embodiment of the present invention, a method of using a rotary fluid (and/or slurry) pump 100 is provided where the pump 100 comprises an integrated pressurized pump shaft seal assembly 102, and operation of the pump 100 such as by rotation of pump shaft 112 by pump motor 101 also directly rotates integrated oil pump 104 so as to pressurize oil in seal chamber 105 for desirably preventing and/or reducing seal failure in pump 100. In a further embodiment, a method of preventing seal failure is provided, comprising providing a rotary fluid (and/or slurry) pump 100 comprising an integrated pressurized pump shaft seal assembly 102, and operation of the pump 100 such as by rotation of pump shaft 112 by pump motor 101 also directly rotates integrated oil pump 104 so as to pressurize oil in seal chamber 105 for desirably preventing and/or reducing ingress of external fluids into seal chamber 105 and/or mechanical seals 107, 117.

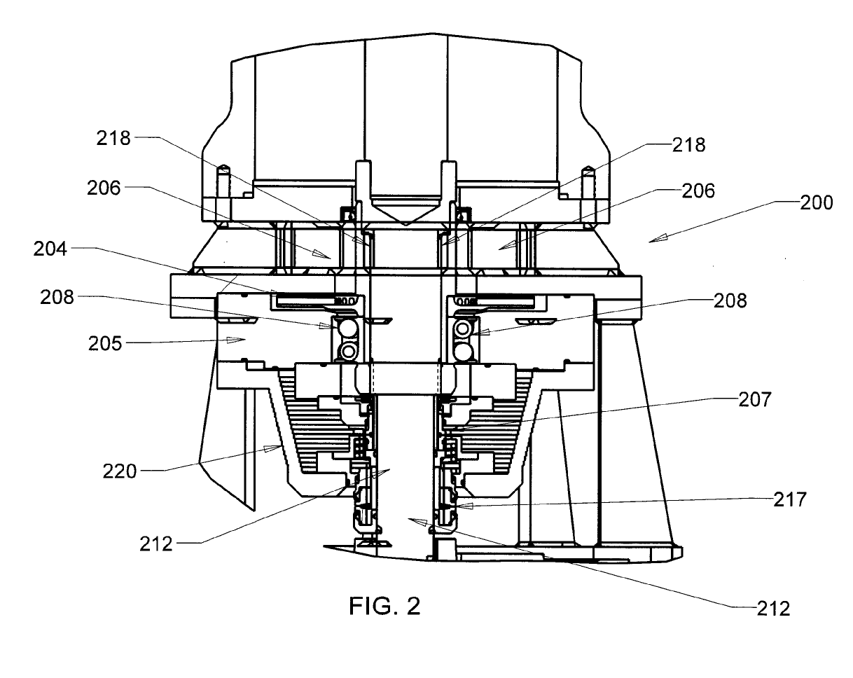

Referring now to FIG. 2, a longitudinal cross sectional view of a portion of a rotary fluid (and/or slurry) pump comprising an integrated pressurized pump shaft seal assembly 200 is shown. Similar to the embodiments of the present invention shown in schematic form in FIG. 1, integrated pressurized pump shaft seal assembly 200 comprises an integrated centrifugal oil pump 204 directly attached to and integrated with pump shaft 212, and situated between an oil reservoir 206 above integrated oil pump 204, and a seal chamber 205 containing pump shaft bearing 208 and situated below integrated oil pump 204. Integrated oil pump 204 is operable to pump oil from oil reservoir 206 to seal chamber 205 to pressurize seal chamber 205 at a positive pressure greater than an ambient pumped fluid pressure outside seal chamber 205. In one embodiment, the integrated pressurized pump shaft seal assembly 200 comprises a dual mechanical seal arrangement comprising an upper mechanical seal 207, and a lower mechanical seal 217, which each comprise two mechanical seal faces engaged in rotational sealing contact with each other to provide a mechanical shaft seal on pump shaft 212. Mechanical seals 207, 217 may comprise any suitable mechanical seal design and/or materials, such as comprising silicon and/or tungsten carbide seal surfaces, for example, and in one embodiment of the present invention, upper and lower mechanical seals 207, 217 may each be provided as a cartridge mechanical seal, for example. Integrated pressurized pump shaft seal assembly 202 including mechanical seals 207 and 217 and further comprising a seal chamber 205 containing oil (or any other suitable seal and/or bearing lubricating fluid for example) may desirably be pressurized at a positive pressure above the ambient or sump pressure outside the seal chamber 205 and may therefore desirably prevent a pumped slurry, fluid or other contaminants from outside seal chamber 205 from entering seal chamber 205 containing and protecting the lower shaft bearings 208, and oil reservoir 206, and desirably also protecting the pump motor located above the oil reservoir 206, for example.

In a particular embodiment, oil pump 204 may comprise a radial hole centrifugal impeller pump, and may be directly attached to and integrated with pump shaft 212 such as by retaining oil pump 204 to shaft 212 by means of a retaining locknut, for example. In a further such embodiment, integrated oil pump 204, pump shaft bearings 208, and optionally also a shaft sleeve (not shown) may be attached to pump shaft 212 by a common retaining locknut, for example, such that rotation of the pump shaft 212 by a pump motor (not shown) directly rotates integrated oil pump 204. In a further embodiment, pump shaft bearings 208 may be at least substantially open to seal chamber 205, such that oil or another suitable lubricating fluid pressurized in chamber 205 by integrated oil pump 204 may provide lubrication to bearings 208. In a further such embodiment, bearings 208 may comprise a bearing housing (not shown) which may desirably comprise a bearing oil pool or reservoir which may retain residual oil to lubricate bearings 208 even if seal chamber 205 loses pressure and is at least partly drained of oil, such as in the event of failure of mechanical seals 207, 217, for example. In a particular embodiment, integrated pressurized pump shaft seal assembly 200 may also comprise at least one lip seal 218 situated between oil reservoir 206 and pump shaft 212 which may desirably provide a further seal barrier between integrated pressurized pump shaft seal assembly 200 and a pump motor above assembly 202, and may desirably provide further protection for a pump motor against ingress of external fluids following failure of both mechanical seals 207, 217, for example.

In one embodiment, seal chamber 205 may further comprise a seal chamber housing 220 such as to support mechanical seals 207, 217, and enclose seal chamber 205 and pump shaft bearings 208. In one such embodiment, seal chamber housing 220 may desirably comprise a suitable durable material with desirably high thermal conductivity, such as to advantageously provide for effective heat transfer from pressurized oil inside seal chamber 205 to a pumped fluid (such as a pumped fluid in a sump, for example), which may desirably provide for cooling of the pressurized oil inside chamber 205, for example.

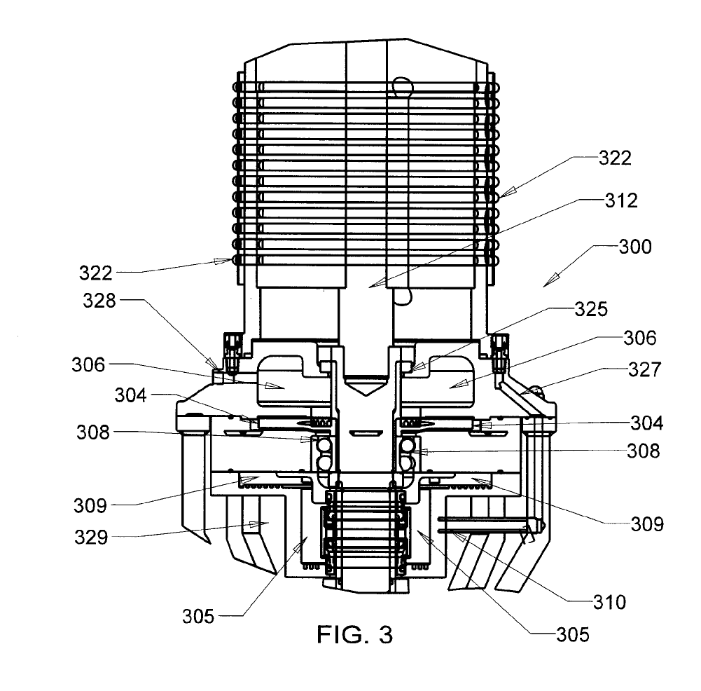

Referring now to FIG. 3, an inset longitudinal cross sectional view of internal details of a portion of a rotary fluid (and/or slurry) pump comprising an integrated pressurized pump shaft seal assembly 300 is shown. Similar to the embodiments of the present invention shown in and described above in FIGS. 1 and 2, integrated pressurized pump shaft seal assembly 300 comprises an integrated centrifugal oil pump 304 directly attached to and integrated with pump shaft 312, and situated between an oil reservoir 306 above integrated oil pump 304, and a seal chamber 305 containing pump shaft bearing 308 and situated below integrated oil pump 304. Integrated oil pump 304 is operable to pump oil from oil reservoir 306 to seal chamber 305 to pressurize seal chamber 305 at a positive pressure greater than an ambient pumped fluid pressure outside seal chamber 305, for example. In one embodiment, the integrated pressurized pump shaft seal assembly 300 comprises a dual mechanical seal arrangement substantially similar to that shown in FIG. 2 and described above, such as to allow for pressurizing seal chamber 305 with oil (and/or another suitable bearing lubricating fluid for example) at a positive pressure above the ambient or sump pressure outside the seal chamber 305 and may therefore desirably prevent a pumped slurry, fluid or other contaminants from outside seal chamber 305 from entering seal chamber 305 containing and protecting the lower shaft bearings 308, and oil reservoir 306, and desirably also protecting the pump motor located above the oil reservoir 306, for example.

In a particular embodiment, oil pump 304 may comprise a radial hole centrifugal impeller pump, and may be directly attached to and integrated with pump shaft 312 such as by retaining oil pump 304 to shaft 312 by means of a retaining locknut, for example. In a further such embodiment, integrated oil pump 304, pump shaft bearings 308, and optionally also a shaft sleeve (not shown) may be attached to pump shaft 312 by a common retaining locknut, for example, such that rotation of the pump shaft 312 by a pump motor directly rotates integrated oil pump 304. In a further embodiment, pump shaft bearings 308 may be at least substantially open to seal chamber 305, such that oil or another suitable lubricating fluid pressurized in chamber 305 by integrated oil pump 304 may provide lubrication to bearings 308. In a further such embodiment, bearings 308 may comprise a bearing housing (not shown) which may desirably comprise a bearing oil pool or reservoir which may retain residual oil to lubricate bearings 308 even if seal chamber 305 loses pressure and is at least partly drained of oil, such as in the event of failure of mechanical seals sealing the bottom of seal chamber 305, for example. In a particular embodiment, integrated pressurized pump shaft seal assembly 302 may also comprise at least one lip seal 325 situated between oil reservoir 306 and pump shaft 312 which may desirably provide a further seal barrier between integrated pressurized pump shaft seal assembly 300 and a pump motor above assembly 300, and may desirably provide further protection for a pump motor against ingress of external fluids following failure of mechanical seals.

In one embodiment of the present invention, integrated pressurized seal assembly 300 further comprises a check valve 309, located between integrated oil pump 304 and pressurized seal housing 305. In a particular such embodiment, check valve 309 may desirably be operable to prevent backflow of oil from seal chamber 305 to oil reservoir 306, through integrated oil pump 304, such as may otherwise occur upon shutdown of the pump motor, and may undesirably lead to contamination of oil reservoir 306 following eventual failure of mechanical seals below seal chamber 305, for example. Since mechanical seals are subject to wear and eventual failure upon extended operation of a rotary pump, particularly in harsh operation such as in pumping abrasive slurries, even with the assistance of pressurized seal chamber 305 which may desirably exclude pumped fluid (such as a pumped slurry) from entering mechanical seals during normal operation, check valve 309 may also be operable to close upon detection of failure of a mechanical seal, such as to keep pumped fluid and/or moisture from entering oil reservoir 306, such as through the integrated oil pump 304. In one such embodiment, check valve 309 may comprise a pressure-actuated valve such that the check valve 309 closes if the pressure in the seal chamber 305 decreases below a desired minimum pressure, and whereby such closing of valve 309 may desirably reduce or prevent admission of fluid to oil reservoir 306. In another such embodiment, a sensor (not shown) may be provided that is operable to detect failure of a mechanical seal below chamber 305, and to trigger closure of check valve 309 upon such failure. In another embodiment, a sensor may also be provided that may trigger an alarm or other suitable indication (such as an indicator light or signal for example) to notify a user of the failure of a mechanical seal. In a further optional embodiment, one or more sensors may also be provided to detect one or more of: failure of mechanical seals (not shown); low oil level in oil reservoir 306; water and/or moisture ingress in to seal chamber 305; and a drop in oil pressure in seal chamber 305 below a desired minimum level; faults, and such sensor(s) may further be operable to trigger an alarm or other suitable indication to notify a user of one or more of such faults.

In another embodiment of the present invention, the integrated pressurized pump seal assembly 300 may additionally comprise a cooling jacket 322, such as for circulating oil (or other suitable lubricating fluid) from oil reservoir 306 under pressure from oil pump 304, to cool a pump motor (desirably located at least partially within cooling jacket 322). In one such embodiment, such as for use in a semi-submerged pump, oil from oil reservoir 306 may be pumped into seal chamber 305 by integrated oil pump 304 driven by rotation of pump shaft 312, to pressurize seal chamber 305 at a positive pressure above an outside ambient fluid pressure, and a portion of oil in seal chamber 305 may be admitted through a pressure reducing valve 310 (which may normally be open) to circulate through cooling jacket 322 surrounding at least a portion of the pump motor. Such circulation of oil from seal chamber 305 through pressure reducing valve 310 and thereafter through a cooling oil supply conduit 327 to cooling jacket 322, then through returning to oil reservoir 306 through cooling oil return conduit 328, before returning to seal chamber 305 under pressure from integrated oil pump 304, may desirably circulate heat from the pump motor to seal chamber 305, where the circulated oil may be cooled by typically cooler surrounding ambient pumped fluid located outside of the seal chamber 305, such as in sump 329, for example. In one such embodiment, pressure reducing valve 310 may desirably be configured to maintain a desired minimum positive pressure in seal chamber 305 such as by limiting and/or controlling flow of oil through pressure reducing valve 310 and cooling jacket 322, for example, to maintain pressurization of seal chamber 305 at or above the desired minimum positive pressure. In a particular embodiment, seal chamber 305 and any optional surrounding housing around seal chamber 305 (not shown) may desirably be comprised of a suitably thermally conductive material, such as aluminum for example, so as to desirably allow dissipation of heat from oil in seal chamber 305 (and optionally also from oil reservoir 306) to typically cooler pumped fluid located outside of the chamber 305 and/or housing, such as a pumped fluid in sump 329. In one such embodiment, walls of seal chamber 305 and/or a further optional seal chamber housing may additionally include cooling fins or other suitable structures such as to improve heat dissipation from the oil chamber 305 to an ambient fluid outside of the chamber.

Similar to the check valve 309 described above, pressure reducing valve 310 may also be operable to close upon detection of failure of a mechanical seal below seal chamber 305, such as to keep pumped fluid and/or moisture from entering cooling jacket 322. In one such embodiment, a sensor (not shown) may be provided that is operable to detect failure of a mechanical seal below seal chamber 305, and to trigger closure of pressure reducing valve 310 upon such failure. In another embodiment, a sensor may also be provided that may trigger an alarm or other suitable indication (such as an indicator light or signal for example) to notify a user of the failure of a mechanical seal. In an optional, an optional oil filter (not shown) may be provided such as between the seal chamber 305 and the check valve 309, or between the oil reservoir 306 and the oil pump 304, for example, to desirably provide additional protection against contamination of the oil in seal chamber 305 and provide increased bearing life of bearings 308.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof.

1. An integrated pressurized pump shaft seal assembly for a rotary fluid pump, the integrated pressurized pump shaft seal assembly comprising:
an oil reservoir;
an integrated centrifugal oil pump directly attached to and rotatable by a pump shaft and fluidly connected to receive oil from the oil reservoir;
a seal chamber fluidly connected to receive pressurized oil from the centrifugal oil pump and comprising:
a pump shaft bearing adapted to be lubricated by said oil; and
a mechanical shaft seal surrounding the pump shaft and adapted to seal the seal chamber against ingress of a pumped fluid.

2. The integrated pressurized pump shaft seal assembly according to claim 1, wherein said mechanical shaft seal comprises first and second mechanical shaft seals.

3. The integrated pressurized pump shaft seal assembly according to claim 1, additionally comprising a check valve located between said integrated centrifugal oil pump and said seal chamber.

4. The integrated pressurized pump shaft seal assembly according to claim 1, additionally comprising a cooling jacket adapted for cooling a pump motor, wherein said cooling jacket is fluidly connected to said seal chamber by a pressure reducing valve and adapted to receive pressurized oil from the seal chamber.

5. The integrated pressurized pump shaft seal assembly according to claim 1, additionally comprising at least one sensor adapted to detect a failure of said mechanical shaft seal.

6. The integrated pressurized pump shaft seal assembly according to claim 5, wherein said sensor is further adapted to trigger closure of at least one of a check valve located between said oil pump and said seal chamber, and a pressure reducing valve fluidly connected to said seal chamber.

7. The integrated pressurized pump shaft seal assembly according to claim 1, additionally comprising a bearing housing containing said pump shaft bearing, wherein said housing comprises a diffuser adapted to receive pressurized oil from said oil pump and to convert a fluid velocity of said pressurized oil to a static pressure.

8. The integrated pressurized pump shaft seal assembly according to claim 1, additionally comprising a seal chamber housing, wherein said seal chamber housing encloses said seal chamber, and further comprises one or more of: cooling fins adapted to cool said pressurized oil in said seal chamber; and baffles adapted to reduce at least one of swirl and cavitation in said pressurized oil in the vicinity of said mechanical seal.

9. The integrated pressurized pump shaft seal assembly according to claim 1, additionally comprising a locking nut adapted to clamp said shaft bearing and said oil pump to said pump shaft.

10. The integrated pressurized pump shaft seal assembly according to claim 1, additionally comprising a pressure compensation device adapted to compensate for an external submergence pressure on said assembly.

11. A rotary fluid pump comprising a pump motor, a pump shaft connected to said pump motor and a pump impeller, and further comprising the integrated pump shaft seal assembly according to claim 1 adapted for connection to said pump shaft.

12. A method of preventing seal failure in a rotary fluid pump, said method comprising:
providing a rotary fluid pump comprising an integrated pressurized pump shaft seal assembly comprising: an oil reservoir; an integrated centrifugal oil pump directly attached to and rotatable by a pump shaft and fluidly connected to receive oil from the oil reservoir; a seal chamber fluidly connected to receive pressurized oil from the centrifugal oil pump and comprising a pump shaft bearing adapted to be lubricated by said oil; and a mechanical shaft seal surrounding the pump shaft and adapted to seal the seal chamber against ingress of a pumped fluid; and
operating said rotary fluid pump by rotating said pump shaft with a pump motor wherein said pump shaft also directly rotates said integrated oil pump to pressurize oil in said seal chamber to prevent ingress of a pumped fluid into said seal chamber.
